(19) United States
(12) Patent Application Publication
(10) Pub. No.: US 2025/0077814 A1
(43) Pub. Date: Mar. 6, 2025

(54) EMBEDDING RECOGNITION DATA IN AN APPARATUS FOR UTILIZING THREE DIMENSION PRINTING FOR SECURE VALIDATION

(71) Applicant: SUSAN LEEDS LIEFF, Santa Barbara, CA (US)

(72) Inventor: SUSAN LEEDS LIEFF, Santa Barbara, CA (US)

(21) Appl. No.: 18/241,839

(22) Filed: Sep. 1, 2023

(51) Int. Cl. G06K 7/14; G06K 1/12

(52) U.S. Cl. CPC G06K 7/1426; G06K 1/121

(57) ABSTRACT

An apparatus and method for embedding such additional information, such as a photograph or a thumbprint, onto a three-dimensional printed entity for secure validation, with that such additional information.

This is an improvement patent of U.S. Pat. No. 9,004,362 B1, issued Apr. 14, 2015

The patent U.S. Pat. No. 9,004,362 B1, filed Sep. 29, 2013, issued April 114, 2015, is hereby incorporated by reference.

### FIELD OF THE INVENTION

This invention relates to embedded recognition data.

This invention relates to three-dimensional printing for secure validation according to U.S. Pat. No. 9,004,362 B1, cited above.

### BACKGROUND OF THE INVENTION

Bar codes have been used to identify objects for some time. These are linear sequence of black bars against a white (or light) background. To increase the amount of information encoded, two-dimensional codes in both an “x” and a “y” direction were developed. A more secure approach is to have actual three-dimensional codes (“x”, “y” and “z” directions) printed by the techniques of three-dimensional printing. Additionally, ‘light-field’ cameras have been developed which can capture a more complete depth of field than conventional cameras and which can show different focal planes of a scene upon demand. A highly secure 3-dimensional “bar code” results.

It would be desirable to additionally add a clandestine coded personal identifier, such as a head photograph and/or a fingerprint (or prints). For example, if an identification badge, drivers license, voter registration, parking sticker, gun permit currency, or a tool or key associated with a person, or aircraft electronic replacement units handled by a particular person, is issued, that person's identifying information would preferably be added to the 3-dimensional bar code such as to make it an individualized item.

### SUMMARY OF THE INVENTION

The underlying invention uses three-dimensional printing techniques to lay down a three-dimensional black and white grid or “4-dimensional” grid, if color is used). A light-field camera is used to capture the whole three-dimensional structure and the focus levels are then determined for a predetermined number of vertical levels, say, 1000.

The improvement to this underlying invention is apply a layer of, say, 10 subdivisions of a level, so that in the additional top layer there is a range of 0 to 10 subdivisions, each subdivision corresponding to a grey-level value. However, the size of this extra layer should be between 0.25 to 0.5 of the layer thickness. This is to ensure that a “fiduciary” or bottom of this layer is evident.

Each grey level value is derived from the processing of a face photograph and one or more fingerprints. That is, the information from a face photograph of the assignee of a unit with a secure 3-dimensional bar code is applied to the upper surface of the 3-dimensional bar code (and same for fingerprint(s).) via 3-dimensional printing.

This additional information may be added at the initial 3-dimensional printing of the 3-dimensional barcode, or it may be printed later, as an add on.

This additional information may be added to the underlying 3-dimensional barcode in a plurality of positions, i.e., it might be added to each of a quarter of the 3-dimensional barcode, viewed from above.

This allows the light-field camera to decode a plurality of copies of this additional information, so as to provide redundancy. An averaging of values of the, say, four copies, may be used, or a vote of the majority of the copies may be used, with an appropriate “tie-breaker” if there are an even number of redundant copies of the added information.

The information of the top layer is read by the light field camera in the upper layer of the added-to 3-dimensional barcode, sublayer by sublayer, and is then processed digitally to reconstruct a facial image and/or fingerprints.

Any other identifying information, as to the assignee of a particular item with its 3-dimensional barcode can also be used in addition to, or in place of, a face picture and fingerprint(s).

### BRIEF DESCRIPTION OF THE DRAWINGS

For a more complete understanding of the present invention, and the advantages thereof, reference is now made to the following descriptions taken in conjunction with the accompanying drawings, in which:

FIG. 1a (prior art) depicts a three dimensional black-and-white “bar code”, location in three dimensional co-ordinates, as printed;

FIG. 1b (prior art) depicts the three-dimensional bar-code with non-uniform dimensional measures in the x-, y-, and z-directions;

FIG. 2 (prior art) diagrams the steps in formulating and printing a three/four dimensional “bar code”;

FIG. 3 (prior art) diagrams the steps in retrieving the information from a three/four dimensional “bar code”;

FIG. 4 (prior art) shows a schematic of a light-field camera with associated processing.

FIG. 5 demonstrates the separation of a top-layer 3-dimensional printed layer into 10 subdivisions corresponding to 10 levels of grey scale.

FIG. 6 shows the processing of additional identification information into a digital format and incorporation into the 3-dimensional barcode. Further, the readout from the 3-dimensional barcode is shown, which then reads out as visual identifiers such as a face picture or a fingerprint, pertaining to an individual.

### DETAILED DESCRIPTION OF THE BEST MODE OF THE INVENTION

The following description is of the best mode presently contemplated for carrying out the invention. This description is not to be taken in a limiting sense, but is merely made for the purpose of describing the general principles of the invention.

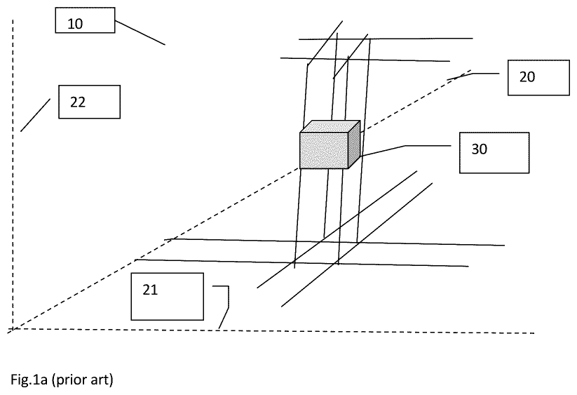

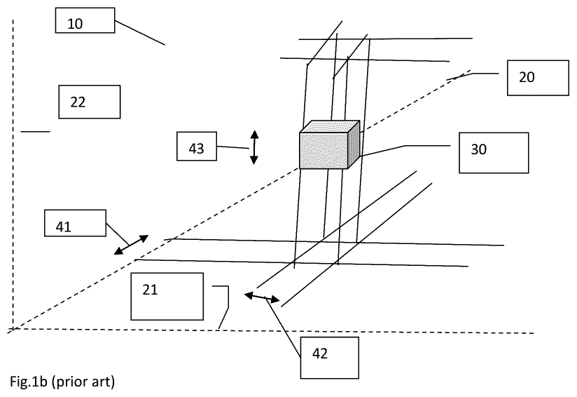

FIG. 1a (prior art) shows a nominal three-dimensional black and white printed bar code, in a sketched fashion 10. Three-dimensional printing has been developed as a method for making objects by building them up from repeated layers of an appropriate substance. As shown it is in black and white. That is, the heights of each two-dimensionally located grid square has a detectable height 30. This allows for the positional encoding of information. There are thus N³ available points in space, where N 20. 21, 22 is a uniform linear dimension with N points reliably discriminated.

FIG. 1b (prior art) depicts, for rectangular dimensions, with different linear lengths, the number of encodable points is thus (length, l) 41×(width, w) 42×(height, h) 43, or, lwh, with l, w, and h points being the number of points in each dimension that can be reliably discriminated and determined.

Note that the reference is to actual three-dimensionally located points. In some versions of actual one and two dimensional bar codes, the height of a bar may be varied, in that system, to achieve another “dimension”, quite legitimately. However, distinguishing, in this invention, the third dimension is the 43 (FIG. 1b, prior art) actual height. This has the advantage that specialized three-dimensional equipment is required to make and read such three-dimensional bar graphs; they cannot be produced by ordinary printing method or read by ordinary bar-cod readers.

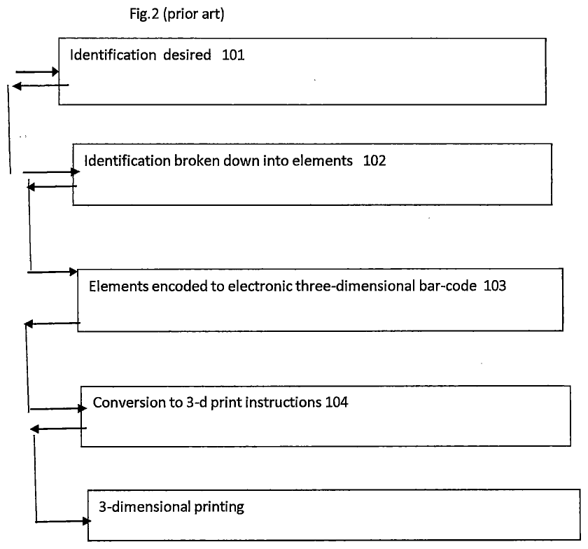

FIG. 2 (prior art) indicates the steps in encoding the three-dimensional printing. First the appropriate identification 101 is selected. The identification selected is then broken down into elements 102, e.g., a name would be broken down into letters and a license plate number might be broken down into numbers and letters. The elements are encoded into an electronic format, expressing a three-dimensional bar code 103. The next step is to convert this electronic 3-dimensional representation into print instructions 104 for the three-dimensional printer. The last step is actually printing in three-dimensions using a three-dimensional printer. The 3-D printer prints with materials appropriate to the vertical resolution desired.

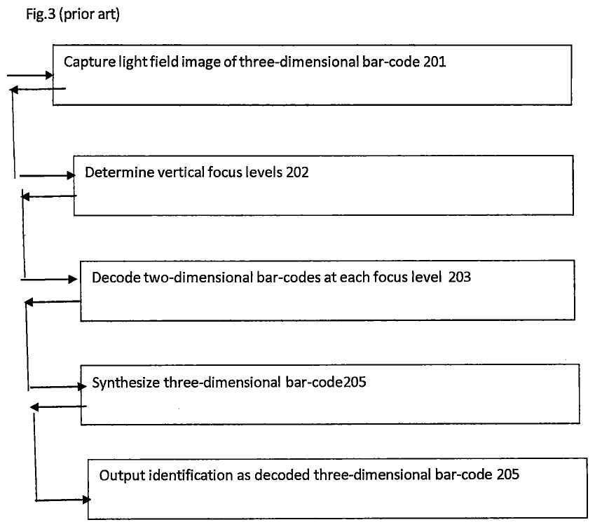

FIG. 3 (prior art) indicates the steps to capture the image of the three-dimensional bar-code and to decode it. First a light field camera captures the total image 201 of the three-dimensional bar code since the light field camera is not limited to a single focal plane. The next step is to determine the various resolvable focus levels. In the case where color is a dimension, fiduciary columns which have different colors arranged in an order vertically, may be used to aid the identification of the vertical focus levels. A with bar codes in general, certain positions, horizontal as well as vertical may be used to provide fiduciary information to assist in decoding the three-dimensional bar-code. The next step in to decode the two-dimensional bar-codes which comprise each vertical focus level 203.

The three-dimensional bar-code is then synthesized 204 from the two-dimensional bar codes at each focus level.

From this, identification is output from decoding 205 (FIG. 3, prior art) the three-dimensional bar-code, inverting the step 103 of FIG. 2 (prior art).

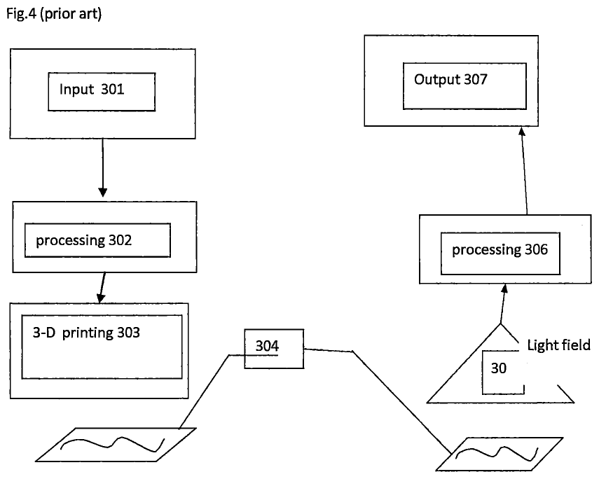

FIG. 4 (prior art) shows the light field camera and the associated processor for capturing and decoding the three-dimensional bar-code.

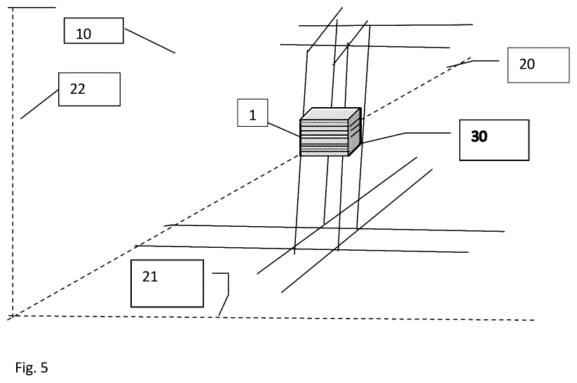

FIG. 5 demonstrates the separation of a top-layer 3-dimensional printed layer into 10 subdivisions corresponding to 10 levels of grey scale. The actual thickness of the top-layer should be between 0.25 to 0.5 so as to allow the detection of the zero level of this extra layer.

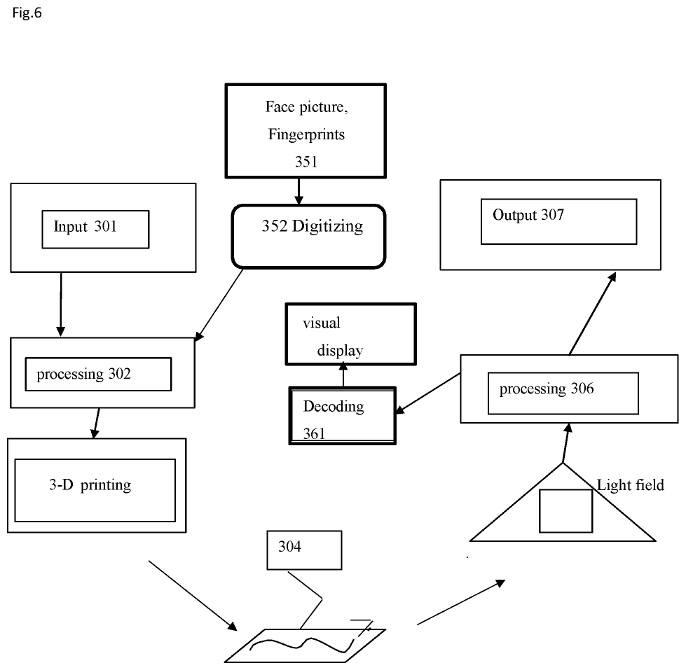

FIG. 6 shows the processing of additional identification information 351 into a digital format 352. Then this digitized information is fed into the processor for incoming information for the 3-dimensional printing 302 whereupon it is used to add top sublayers via 3-dimensional printing 303. Then the 3-dimensional barcode is shown 304. This can be read by a light-field camera 305 and the various layers selected out by the processor 306. A subset of this readout is sent to a decoder 361 which then outputs visual information 362.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention.

1-4. (canceled)

5. A system for embedding recognition data in a three-dimensional bar code utilizing three-dimension printing for secure validation and reading the recognition data, comprising:
a digitizer for digitizing the recognition data comprising face picture and fingerprints or other, wherein the face picture is digitized based on its greyscale equivalent and wherein the fingerprints are digitized based on its binary (black and white) equivalents;
a three-dimensional printer;
a first processor which directs the three-dimensional printer to print prints a three-dimensional bar code and accepts the digitized recognition data and directs the three-dimensional printer to print a three-dimensional representation of the digitized recognition data over the underlying three-dimensional barcode which has N maximum layers, wherein N is a number, such as 10 or 100, or other, and wherein each layer is of depth D wherein D is a dimensioned number representing depth, such as 0.1 mm;
the three-dimensional representation of the recognition data forming a layer over the underlying three-dimensional bar code wherein the recognition data layer total depths is kept to the equivalent of 0.25 to 0.5 of the individual layer of the underlying 3-dimensional barcode, viz. 0.25 D to 0.5 D;
a light-field camera wherein the light-field camera captures all three-dimensional depths simultaneously and wherein the light-field camera can differentiate the layers of the added recognition layer; and
a second processor which converts light-field camera data to digital data wherein the processor distinguishes m/N layers (0<m<N) and a net recognition layer depth of order 0.25 to 0.5 D and assigns m/N layers to the underlying three-dimensional bar code and the layers within the recognition layer, 0.25 D to 0.5 D, to the recognition data reconstruction; and
an output device displaying the underlying digital data corresponding to various grey scale values and binary values (black and white) wherein the values are used to form a visual representation on a display device or used to print a grey-scale face picture and black and white fingerprint pictures.

6. The system of claim 5 wherein a recognition layer can be printed over an existing three-dimensional barcode, for suitable three-dimensional printing materials.

7. A method for embedding recognition data in a three-dimensional bar code utilizing three-dimension printing for secure validation and reading the recognition data, comprising:
digitizing with a digitizer the recognition data comprising face picture and fingerprints or other, wherein the face picture is digitized based on its greyscale equivalent and wherein the fingerprints are digitized based on its binary (black and white) equivalents;
printing with a three-dimensional printer;
processing with a first processor, directing the three-dimensional printer to print prints a three-dimensional bar code and accepting the digitized recognition data and directing the three-dimensional printer to print a three-dimensional representation of the digitized recognition data over the underlying three-dimensional barcode which has N maximum layers, wherein Nis a number, such as 10 or 100, or other, and wherein each layer is of depth D wherein D is a dimensioned number representing depth, such as 0.1 mm;
forming the three-dimensional representation of the recognition data as a layer over the underlying three-dimensional bar code wherein the recognition data layer total depths is kept to the equivalent of 0.25 to 0.5 of the individual layer of the underlying 3-dimensional barcode, viz. 0.25 D to 0.5 D;
capturing all three-dimensional depths simultaneously utilizing a light-field camera and utilizing the light-field camera with capability of differentiating the layers of the added recognition layer; and
converting the light field data to digital data utilizing a second processor which converts light-field camera data wherein the processor distinguishes m/N layers (0<m<N) and a net recognition layer depth of order 0.25 to 0.5 D and assigning m/N layers to the underlying three-dimensional bar code and assigning the layers within the recognition layer, 0.25 D to 0.5 D, to the recognition data reconstruction; and
an output device displaying the underlying digital data corresponding to various grey scale values and binary values (black and white) wherein the values are used to form a visual representation on a display device or used to print a grey-scale face picture and black and white fingerprint pictures.

8. The method of claim 7 wherein a recognition layer can be printed over an existing three-dimensional barcode, for suitable three-dimensional printing materials.
